(19) United States
(12) Patent Application Publication
(10) Pub. No.: US 2012/0072012 A1
(43) Pub. Date: Mar. 22, 2012

(54) SHEET PROCESSING APPARATUS AND SHEET PROCESSING METHOD

(75) Inventors: Mitsutake Hasebe, Kawasaki-shi (JP); Naotake Natori, Kunitachi-shi (JP)

(73) Assignee: KABUSHIKI KAISHA TOSHIBA, Tokyo (JP)

(21) Appl. No.: 13/030,359

(22) Filed: Feb. 18, 2011

(30) Foreign Application Priority Data
Sep. 16, 2010 (JP) 2010-208487

(51) Int. Cl. G06K 9/46; G06F 7/00

(52) U.S. Cl. 700/223; 382/190

(57) ABSTRACT

According to one embodiment, sheet processing includes feature-amount extraction unit configured to extract feature amount from image obtained, standard pattern storage unit configured to prestore standard pattern group for each different soil level, standard pattern group includes standard pattern for each category, selection unit configured to select one standard pattern group from standard pattern groups, similarity calculation unit configured to calculate similarity, based on standard pattern comprised in one standard pattern group selected, and on feature amount extracted, comparison unit configured to compare similarity calculated with preset threshold, determination unit configured to determine category of sheet when similarity is equal to or greater than threshold, as result of comparison, and control unit configured to control selection unit to select one other standard pattern group which has not been selected, when similarity is smaller than threshold, as result of comparison.

### CROSS-REFERENCE TO RELATED APPLICATIONS

This application is based upon and claims the benefit of priority from Japanese Patent Application No. 2010-208487, filed Sep. 16, 2010; the entire contents of which are incorporated herein by reference.

### FIELD

Embodiments described herein relate generally to a sheet processing apparatus and a sheet processing method.

### BACKGROUND

Sheet processing apparatuses which inspect various types of sheets, such as paper sheets, etc., have already been put to practical use. In sheet processing apparatuses, sheets which are slotted in a slot-in unit are loaded in one after another and conveyed to an inspection unit.

The inspection unit comprises a detection unit which detects features of sheets. The inspection unit causes the detection unit to detect a feature amount from a sheets being conveyed in a predetermined direction. For example, the detection unit determines a category (or denomination) of a sheet based on a detection result. Alternatively, for example, the detection unit determines a conveying state of a sheet based on a detection result. Also alternatively, the detection unit determines authentication of a sheet based on a detection result. Still alternatively, the detection unit determines whether a sheet is recirculatable or not, based on a detection result.

For example, the inspection unit prestores, as a dictionary, a standard pattern for each of categories of sheets to be inspected. The inspection unit compares a detection result of the detection unit with standard patterns in the dictionary, and makes various determinations, based on comparison results thereof.

However, features of sheets may change because sheets are worn or soiled during circulation. In order to cope with change of features of sheets, the inspection unit comprises plural standard patterns for each category in some case. In this case, the inspection unit compares all the standard patterns stored in the dictionary with a detection result of the detection unit. Therefore, there is a problem that processings require a long time.

### BRIEF DESCRIPTION OF THE DRAWINGS

FIG. 1 is a view showing for explaining an example configuration of a sheet processing apparatus according to one embodiment;

FIG. 2 is a view showing for explaining a configuration example of a category detection unit according to the embodiment;

FIG. 3 is a view showing for explaining a configuration example of a dictionary according to the embodiment;

FIG. 4 is a view showing for explaining an operation of the sheet processing apparatus according to the embodiment;

FIG. 5 is a view showing for explaining an example configuration of a category detection unit according to the embodiment; and

FIG. 6 is a view showing for explaining an operation of the sheet processing apparatus according to the embodiment.

### DETAILED DESCRIPTION

In general, according to one embodiment, a sheet processing apparatus which determines a category of a sheet, comprises: an image obtaining unit configured to obtain an image from the sheet; a feature-amount extraction unit configured to extract a feature amount from the image obtained by the image obtaining unit; a standard pattern storage unit configured to prestore a standard pattern group for each different soil level, the standard pattern group comprising a standard pattern for each category; a selection unit configured to select one standard pattern group from a plurality of standard pattern groups prestored in the standard-pattern storage unit; a similarity calculation unit configured to calculate a similarity, based on at least one standard pattern comprised in the one standard pattern group selected by the selection unit, and on the feature amount extracted by the feature-amount extraction unit; a comparison unit configured to compare the similarity calculated by the similarity calculation unit with a preset threshold; a determination unit configured to determine a category of the sheet when the similarity is equal to or greater than the threshold, as a result of comparison by the comparison unit; and a control unit configured to control the selection unit to select one other standard pattern group which has not been selected among the plurality of standard pattern groups stored in the standard-pattern storage unit, when the similarity is smaller than the threshold, as a result of comparison by the comparison unit.

Hereinafter, a sheet processing apparatus and a sheet processing method according to one embodiment will be described with reference to the drawings.

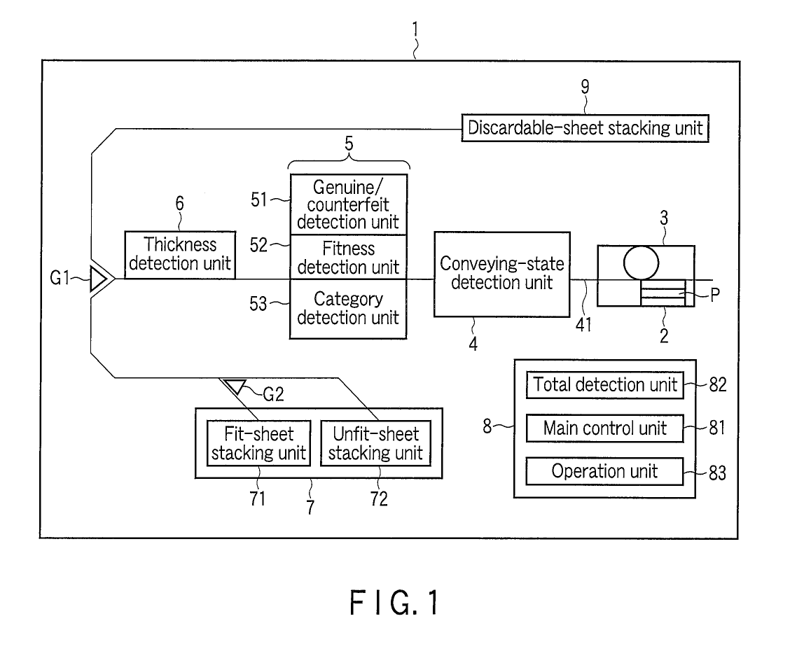

FIG. 1 is a view showing for explaining an example configuration of a sheet processing apparatus 100 according to the embodiment.

The sheet processing apparatus 100 inspects sheets P, based on operations of an operator. The sheet processing apparatus 100 stacks and/or seals the inspected sheets P by a stacking unit.

The sheet processing apparatus 100 comprises a feed unit 2, a load unit 3, a conveying-state detection unit 4, an inspection unit 5, a thickness detection unit 6, a stacking unit 7, a control unit 7, a discardable-sheet stacking unit 9, and a conveyor unit 6. Further, the sheet processing apparatus 100 comprises a first gate G1 and a second gate G2 for switching a conveying destination for the sheets P.

The feed unit 2 stocks the sheets P to load into the sheet processing apparatus 100. The feed unit 2 comprises an insertion slot which receives a bunch of stacked sheets P together.

The load unit 3 comprises a separation roller. The separation roller is provided at an upper end of the feed unit 2. When sheets P are slotted in the feed unit 2, the separation roller then touches an upper end of the set sheets P in a stacking direction thereof. The separation roller rotates thereby loading, into an inner unit of the sheet processing apparatus 100, one after another of the sheets P set in the feed unit 2 from the upper end in the stacking direction.

The separation roller loads, for example, one sheet P for each turn. Accordingly, the separation roller loads in the sheets P at a predetermined interval. The sheets P loaded by the separation roller are introduced into a conveyor unit 41.

The conveyor unit 41 is to convey the sheets P to each of units in the sheet processing apparatus 100. The conveyor unit 41 comprises an unillustrated belt and an unillustrated drive pulley. The conveyor unit 41 drives the drive pulley by an unillustrated drive motor. The conveyor belt is operated by the drive pulley.

The conveyor unit 41 conveys the sheets P, which have been loaded by the load unit 3, at a constant speed further by the conveyor belt. The following descriptions will be made supposing that, a side of the conveyor unit 41 which is close to the load unit 3 is an upstream side while an opposite side to the upstream side is a downstream side.

The conveying-state detection unit 4 detects a conveying state of each sheet P conveyed by the conveyor unit 41. The conveying-state detection unit 4 detects a position, a skew amount, and a gap of each sheet P on a conveyor route.

For example, the conveying-state detection unit 4 detects a conveying error by specifying a center of a sheet P and by further measuring a distance from the specified center. As another example, the conveying-state detection unit 4 detects a skew amount by measuring an inclination of a sheet P to a conveying direction. As still another example, the conveying-state detection unit 4 detects a gap by measuring a distance between a tail end of a sheet P in the conveying direction and a head end of a next sheet P in the conveying direction.

The inspection unit 5 comprises a genuine/counterfeit detection unit 51, a fitness detection unit 52, and a category detection unit 53.

The genuine/counterfeit detection unit 51 detects whether a sheet P is a genuine or an counterfeit. The genuine/counterfeit detection unit 51 comprises, for example, a physical-property detection unit which detects a physical property (feature), and/or a magnetic detection unit. The physical-property detection unit detects, for example, a fluorescent property or an infrared property. The magnetic detection unit detects, for example, a magnetic property from a sheet P. The genuine/counterfeit detection unit 51 determines authentication of a sheet P, based on detection results from the physical-property detection unit and/or the magnetic detection unit.

A fitness detection unit 52 detects whether a sheet P is recirculatable or unrecirculatable. Specifically, the fitness detection unit 52 detects whether a sheet P is a recirculatable fit sheet or an unrecirculatable unfit sheet. For example, the fitness detection unit 52 detects a physical property of a sheet P, and determines whether the sheet P is recirculatable or unrecirculatable, based on a detection result thereof. The fitness detection unit 52 makes a determination on a sheet P which has been determined to be a fit sheet by the genuine/counterfeit (authentication) detection unit 51.

The category detection unit 53 detects a category (or denomination) of a sheet P. The category detection unit 53 detects an optical property from two surfaces of a sheet P. The category detection unit 53 comprises a dictionary which stores a standard pattern for each category.

The category detection unit 53 comprises, for example, an illumination unit which projects light to a sheet P, a sensor which obtains an image from one surface of the sheet P, and a sensor which obtains an image from the other surface of the sheet P. The sensors are positioned so as to face each other over the conveyor unit 41. The sensors each comprise a light receiving element such as a charge coupled device (CCD), and an optical system. The sensors may be configured to obtain an image from one surface of a sheet P.

The category detection unit 53 projects light to a sheet P from an illumination unit. Each of the sensors causes the optical system to receive light which penetrates the sheet P or is reflected on a surface of the sheet P. The optical system forms an image of the received light, on the light receiving element. The light receiving element generates an electric signal (image), based on the image-forming light.

The category detection unit 53 obtains the image from the sheet P. The category detection unit 53 extracts a feature value based on the obtained image. The category detection unit 53 calculates a similarity between the extracted feature value and a standard pattern stored in the dictionary. The category detection unit 53 detects a category of the sheet P, based on the calculated similarity and a preset threshold level. Further, the category detection unit 53 detects a front, a back, a regular direction, and a reverse direction of the sheet P. In the following, the front and back and the regular and reverse directions will be referred to, all together, as a category.

The thickness detection unit 6 detects a thickness of a sheet P conveyed by the conveyor unit 41. The thickness detection unit 6 detects an overlap of plural sheets P and a folding of a sheet P, based on the thickness of the sheet P.

The stacking unit 7 stacks sheets P, sorting the sheets P for each category detected by the inspection unit 5. The stacking unit 7 comprises a fit-sheet stacking unit 71 and an unfit-sheet stacking unit 72. The fit-sheet stacking unit 71 stacks sheets P which have been determined to be genuine and fit sheets by the inspection unit 5. If a number of stacked sheets P reaches a predetermined number of sheets, the fit-sheet stacking unit 71 then seals the sheets P for each predetermined number of sheets. The unfit-sheet stacking unit 72 stacks sheets P which have been determined to be genuine and unfit sheets by the inspection unit 5.

The control unit 8 totally controls operations of individual units in the sheet processing apparatus 100. The control unit 8 comprises a main control unit 81, a total determination unit 82, and an operation unit 83. The main control unit 81 controls operations of the conveyor unit 41, first gate G1, and second gate G2, based on a determination result of the total determination unit 82.

The total determination unit 82 totally determines a conveying destination for a sheet P, based on detection results of the conveying-state detection unit 4, inspection unit 5, and thickness detection unit 6.

For example, the total determination unit 82 determines the fit-sheet stacking unit 71 as a conveying destination for a sheet P which has been determined to be genuine by the genuine/counterfeit detection unit 51 and to be a fit sheet by the fitness detection unit 52. The main control unit 81 controls the first gate G1 and second gate G2 so as to convey the sheet P to the fit-sheet stacking unit 71. Specifically, the main control unit 81 pivots the first gate G1 in an anticlockwise direction as well as the second gate G2 in a clockwise direction.

Otherwise, the total determination unit 82 determines the unfit-sheet stacking unit 72 as a conveying destination for a sheet P which has been determined to be genuine by the genuine/counterfeit detection unit 51 and to be an unfit sheet by the fitness detection unit 52. The main control unit 81 controls the first gate G1 and second gate G2 so as to convey the sheet P to the unfit-sheet stacking unit 72. Specifically, the main control unit 81 controls the first gate G1 to pivot in an anticlockwise direction as well as the second gate G2 pivot in an anticlockwise direction.

Still otherwise, the total determination unit 82 determines the discardable-sheet stacking unit 9 as a conveying destination for a sheet P which has been determined to be counterfeit or discardable by the genuine/counterfeit detection unit 51. The main control unit 81 controls the first gate G1 so as to convey the sheet P to the discardable-sheet stacking unit 9. Specifically, the main control unit 81 controls the first gate G1 to pivot in a clockwise direction.

Still otherwise, if the thickness detection unit 6 detects an overlap of plural sheets P or a folding of a sheet P, the total determination unit 82 determines the discardable-sheet stacking unit 9 as a conveying destination for the sheet P. The main control unit 81 controls the first gate G1 so as to convey the sheet P to the discardable-sheet stacking unit 9. Specifically, the main control unit 81 controls the first gate G1 to pivot in a clockwise direction.

The operation unit 83 comprises, for example, a touch panel or an input unit. The touch panel is formed to integrate a keyboard and a display unit. The input unit receives an operation signal corresponding to an operation of an operator. The operation unit 83 generates an operation signal, based on an input operation. The operation unit 83 inputs the generated operation signal into the main control unit 81. The main control unit 81 generates control signals for performing various processings, based on input operation signals.

The discardable-sheet stacking unit 9 stacks sheets P which have been determined to be counterfeit by the genuine/counterfeit detection unit 51, sheets P which have been determined to be causing an overlap of plural sheets by the thickness detection unit 6, and sheets P which have been determined to be folding by the thickness detection unit 6.

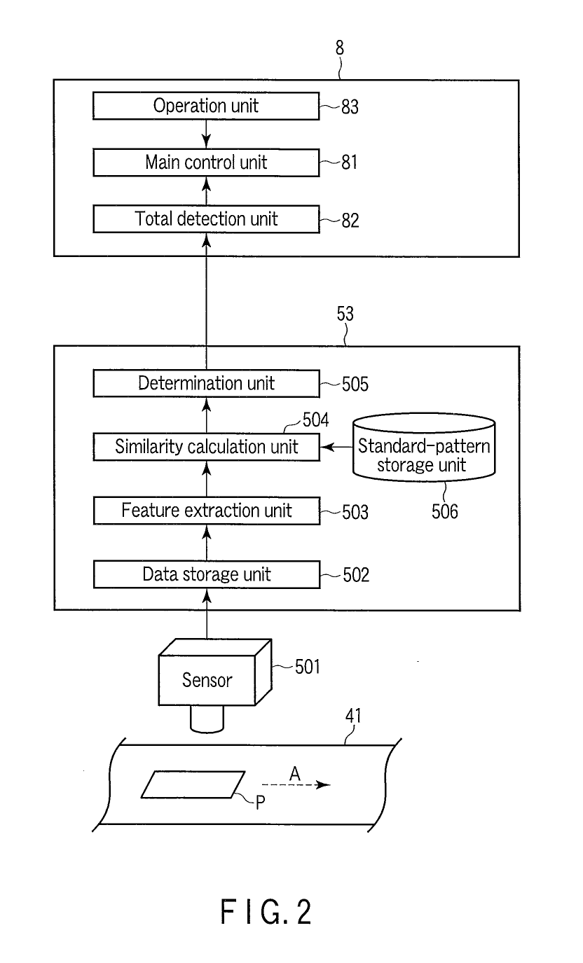

FIG. 2 is a view showing for explaining an example configuration of a category detection unit shown in FIG. 1.

The category detection unit 53 comprises a sensor 501, a data storage unit 502, a feature extraction unit 503, a similarity calculation unit 504, a determination unit 505, and a standard-pattern storage unit 506. The category detection unit 53 further comprises an unillustrated control unit which totally controls operations of individual units in the category detection unit 53.

As described above, the sensor 501 comprises a light receiving element such as a CCD, and an optical system. The category detection unit 53 projects light from an unillustrated illumination unit to sheets P which are conveyed in a direction of arrow A (conveying direction) by the conveyor unit 41. The sensor 501 receives reflected light or transmitted light, to obtain an image. The sensor 501 inputs the obtained image into the data storage unit 502.

The data storage unit 502 temporarily stores the image input from the sensor 501.

The feature extraction unit 503 extracts a feature amount, based on image data input to the data storage unit 502. The image data input to the data storage unit 502 is, for example, an image constituted by two-dimensionally arrayed pixels. Each pixel has a density value. The feature extraction unit 503 extracts a feature amount, based on density values of the image data. The feature extraction unit 503 transfers the extracted feature amount to the similarity calculation unit 504.

The feature extraction unit 503 may alternatively be configured to extract a feature amount, based on derivative values of density values of an image.

The similarity calculation unit 504 calculates similarities between the feature amount extracted by the feature extraction unit 503 and standard patterns stored in the standard-pattern storage unit 506. The similarity calculation unit 504 calculates the similarities, for example, by using a simple similarity method or a multiple similarity method.

The standard-pattern storage unit 506 stores standard patterns for each category detection unit 53. The standard patterns classified for each category are referred to as a standard pattern group. The standard pattern group may include an arbitrary number of types of standard patterns, which is as at least one. The standard-pattern storage unit 506 stores one standard pattern group for each soil level.

The soil level is, for example, a parameter indicating a degree of how a sheet P is worn and soiled. A feature amount of a sheet P varies depending on the soil level. The sheet processing apparatus 100 according to the present embodiment comprises a standard pattern group for each different soil level, and therefore can stably perform a processing on a worn and soiled sheet P.

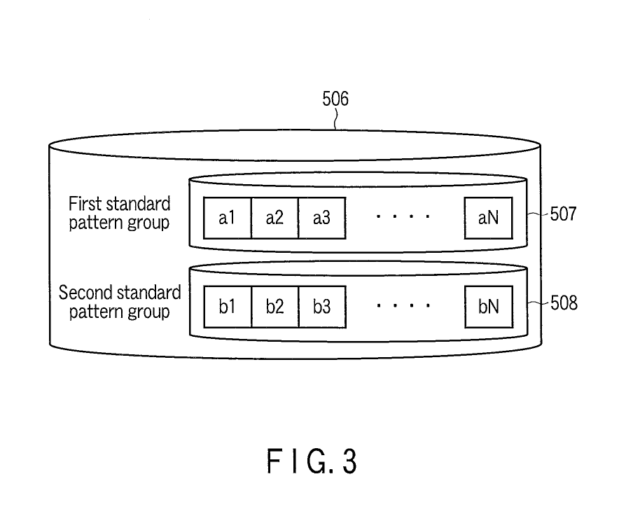

In the present embodiment, for example, as shown in FIG. 3, the standard-pattern storage unit 506 stores, as a first standard pattern group 507, a standard pattern group which is generated from a sheet (e.g., a new bank note) when the sheet was published. The standard-pattern storage unit 506 stores, as a second standard pattern group 508, a standard pattern group which is generated from sheets (e.g., bank notes in circulation) which have been determined to be fit sheets by the fitness detection unit 52. The standard-pattern storage unit 506 may store any number of standard pattern groups.

The standard-pattern storage unit 506 comprises standard pattern groups corresponding to soil levels a to n. The soil levels of the standard pattern groups satisfy a relationship of a≦b≦c . . . <n. Each of the standard pattern groups comprises standard patterns corresponding to categories 1 to N.

In this case, a standard pattern having soil level “a” and category “1” is referred to as “a1”. A standard pattern having soil level “a” and category “2” is referred to as “a2”. A standard pattern having soil level “b” and category “1” is referred to as “b1”. A standard pattern having soil level “n” and category “N” is referred to as “nN”.

In this case, a similarity between the standard pattern “a1” having the soil level “a” and category “1” and a feature amount extracted by the feature extraction unit 503 is referred to as “Sa1”.

A similarity between the standard pattern “a2” having the soil level “a” and category “2” and a feature amount extracted by the feature extraction unit 503 is referred to as “Sa2”. A similarity between the standard pattern “b1” having the soil level “b” and category “1” and a feature amount extracted by the feature extraction unit 503 is referred to as “Sb1”. A similarity between the standard pattern “nN” having the soil level “n” and category “N” and a feature amount extracted by the feature extraction unit 503 is referred to as “SnN”.

The similarity calculation unit 504 firstly calculates a similarity by use of a standard pattern group having the lowest soil level. That is, the category detection unit 53 controls the similarity calculation unit 504 so as to select one standard pattern group which has the lowest soil level and has not yet been selected. In this case, a control unit of the category detection unit 53 functions as a selection unit.

In an example shown in FIG. 3, the first standard pattern group 507 has a lower soil level than the second standard pattern group 508. Therefore, the similarity calculation unit 504 selects the first standard pattern group 507.

The similarity calculation unit 504 calculates a similarity between a feature amount extracted by the feature extraction unit 503 and each of standard patterns a1 to aN which the first standard pattern group 507 comprises. The similarity calculation unit 504 thereby calculates similarities Sa1 to SaN. The similarity calculation unit 504 further specifies a maximum similarity among the similarities Sa1 to SaN. The similarity calculation unit 504 transfers the specified maximum similarity to the determination unit 505.

The determination unit 505 compares the maximum similarity transferred from the similarity calculation unit 504, with a threshold prestored in the standard-pattern storage unit 506. Hence, the standard-pattern storage unit 506 prestores a threshold for each standard pattern group.

For example, the first standard pattern group 507 further has a first threshold T1. The second standard pattern group 508 further has a second threshold T2. An N-th standard pattern group has a threshold SN.

The determination unit 505 compares the maximum similarity transferred from the similarity calculation unit 504, with the first threshold T1. That is, the determination unit 505 compares the maximum similarity transferred from the similarity calculation unit 504, with a threshold which the standard pattern group used for calculating the similarity has.

If the maximum similarity transferred from the similarity calculation unit 504 is not smaller than the first threshold T1, the determination unit 505 determines a category of a sheet P. In this case, the determination unit 505 determines that a category of a standard pattern used for calculating the maximum similarity corresponds to the category of the sheet P. As a result, the determination unit 505 can specify the category of the sheet P. The determination unit 505 transfers a determination result indicating the category of the sheet P to the total determination unit 82 in the control unit 8.

Otherwise, if the maximum similarity transferred from the similarity calculation unit 504 is smaller than the first threshold T1, the determination unit 505 goes to a processing for using a next standard pattern group. The determination unit 505 controls the similarity calculation unit 504 so as to calculate a similarity by use of a standard pattern group having a second lowest soil level.

The similarity calculation unit 504 calculates a similarity between the feature amount extracted by the feature extraction unit 503 and each of standard patterns b1 to bN which the second standard pattern group 508 comprises. The similarity calculation unit 504 thereby calculates similarities Sb1 to SbN. Further, the similarity calculation unit 504 specifies a maximum similarity among the similarities Sb1 to SbN. The similarity calculation unit 504 transfers the specified maximum similarity to the determination unit 505.

The determination unit 505 compares the maximum similarity transferred from the similarity calculation unit 504, with the second threshold T2.

If the maximum similarity transferred from the similarity calculation unit 504 is not smaller than the second threshold T2, the determination unit 505 determines a category of a sheet P. The determination unit 505 transfers a determination result indicating the category of the sheet P to the total determination unit 82 in the control unit 8.

Otherwise, if the maximum similarity transferred from the similarity calculation unit 504 is smaller than the second threshold T2, the determination unit 505 determines the sheet P to be a discardable sheet. That is, if the maximum similarity transferred from the similarity calculation unit 504 is smaller than the second threshold T2 and if any more standard pattern group is not stored in the standard-pattern storage unit 506, the determination unit 505 determines a sheet P to be a discardable sheet. In this case, the determination unit 505 transfers, to the total determination unit 82 in the control unit 8, a determination result indicating that the sheet P is a discardable sheet.

The total determination unit 82 totally determines a conveying destination for a sheet P, based on detection results transferred from individual detection units. The main control unit 81 controls the first gate G1 and second gate G2 so as to convey the sheet P to the conveying destination determined by the total determination unit 82.

The foregoing example has been described to have a configuration in which the standard-pattern storage unit 506 stores the first standard pattern group 507 and second standard pattern group described above, soil levels of which differ from each other. However, the embodiment is not limited to this configuration. A number of standard pattern groups stored in the standard-pattern storage unit 506 may be any arbitrary number which is at least two.

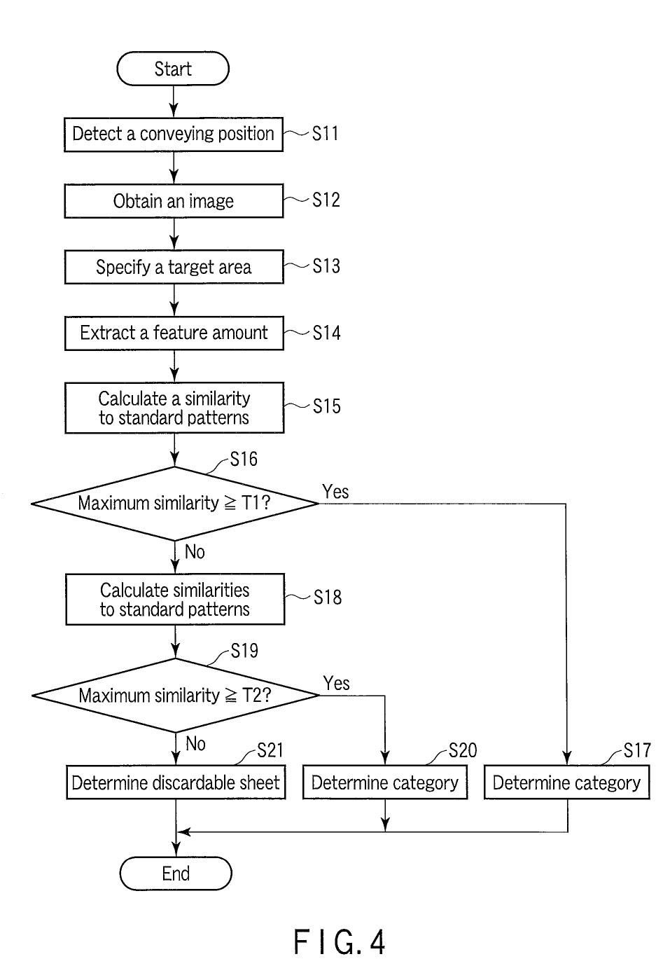

FIG. 4 is a view showing for explaining an operation of the sheet detection unit 53 of the sheet processing apparatus 100.

The category detection unit 53 recognizes a conveying position of a sheet P by using the conveying-state detection unit 4 shown in FIG. 1 or an unillustrated position detection sensor (step S11). The conveying position of a sheet P is recognized based on a level difference between detection signals obtained when the sheet P exists at a detection position of the conveying-state detection unit 4 or position detection sensor and when the sheet P does not exist at the detection position.

If a sheet P is determined to have reached a detection position of the sensor 501 shown in FIG. 2, the category detection unit 53 obtains an image from the sheet P by the sensor 501 (step S12).

The category detection unit 53 specifies a target area from which a feature amount is extracted by the feature extraction unit 503 (step S13). For example, the feature extraction unit 503 specifies a contour of the target area, based on the image obtained by the sensor 501. The feature extraction unit 503 specifies a barycenter of a sheet area surrounded by the specified contour.

For example, the feature extraction unit 503 sets a whole surface of the sheet area as a target area, with reference to the barycenter of the specified sheet area. Otherwise, for example, the feature extraction unit 503 divides the sheet area into plural blocks and sets arbitrary one of the divided plural blocks as a target area.

The category detection unit 53 extracts a feature amount, based on the image obtained by the sensor 501 and the target area which has been set as described above (step S14). Specifically, the category detection unit 53 extracts an image of the target area in the image obtained by the sensor 501. The category detection unit 53 extracts the feature amount, based on density values of the extracted image, derivative values of the density values, or other values.

The category detection unit 53 calculates a similarity between the feature value extracted by the feature extraction unit 503 and standard patterns stored in the standard-pattern storage unit 506 (step S15). Here, the category detection unit 53 selects a standard pattern group having a lowest soil level among standard pattern groups stored in the standard-pattern storage unit 506. In the present embodiment, the category detection unit 53 selects the first standard pattern group 507. The category detection unit 53 calculates each of standard patterns comprised in the first standard pattern group 507 and the feature value extracted by the feature extraction unit 503.

Further, the category detection unit 53 specifies a maximum similarity, based on the calculated similarities. The category detection unit 53 compares a threshold T1 which the selected first standard pattern group 507 has with the specified maximum similarity. Specifically, the category detection unit 53 determines whether the maximum similarity is greater than or equal to the threshold T1 or not (step S16).

If the maximum similarity is not smaller than the threshold T1, the category detection unit 53 determines a category of the sheet P (step S17). Specifically, the category detection unit 53 determines that a category of a standard pattern used for calculating the maximum similarity corresponds to the category of the sheet P.

Otherwise, if the maximum similarity is smaller than the threshold T1, the category detection unit 53 calculates a similarity by using a standard pattern group having a second lowest soil level (step S18). Here, the category detection unit 53 selects a second standard pattern group 508 having a second lowest soil level next to the first standard pattern group 507. The category detection unit 53 calculates a similarity between each of standard patterns comprised in the selected second standard pattern group 508 and the feature amount extracted by the feature extraction unit 503.

Further, the category detection unit 53 specifies a maximum similarity, based on the calculated similarities. The category detection unit 53 compares the threshold T2 which the selected second standard pattern group 508 has with the specified maximum similarity. Specifically, the category detection unit 53 determines whether the maximum similarity is equal to or greater than the threshold T2 or not (step S19).

If the maximum similarity is equal to or greater than the threshold T2, the category detection unit 53 determines a category of the sheet P (step S20). Specifically, the category detection unit 53 determines that a category of a standard pattern used for calculating the maximum similarity corresponds to the category of the sheet P.

Otherwise, if the maximum similarity is smaller than the threshold T2, the category detection unit 53 determines that the sheet P is a discardable sheet (step S21).

Still otherwise, if the maximum similarity is smaller than the threshold T2 and if any more standard pattern group is stored in the standard-pattern storage unit 506, the category detection unit 53 goes to a step S18. Specifically, the category detection unit 53 selects a standard pattern group having a third lowest soil level and performs processings of steps S18 and S19, based on information which the selected standard pattern group has.

As has been described above, the sheet processing apparatus 100 according to the present embodiment comprises the category detection unit 53. The category detection unit 53 comprises a standard pattern group for each of different soil levels. Each standard pattern group comprises a standard pattern for each category and threshold values. The category detection unit 53 calculates similarities, prioritizing a standard pattern group having a lower soil level. If a calculated similarity is not smaller than a threshold, the category detection unit 53 determines a category of a sheet P.

In this manner, when a similarity not smaller than a threshold is calculated, the category detection unit 53 can determine a category of a sheet P without performing a processing which uses any other standard pattern group. Besides, a standard pattern group having a lower soil level is used in priority, and therefore, the category detection unit 53 can improve identification performance and reduce a processing time. As a result, a sheet processing apparatus and a sheet processing method capable of more efficiently performing processings can be provided.

In the above embodiment, the category detection unit 53 has been described to have a configuration of performing processings by using standard patterns stored in the standard-pattern storage unit 506. However, the category detection unit 53 is not limited to this configuration. The category detection unit 53 may be configured to generate standard patterns and perform processings by use of the generated standard pattern.

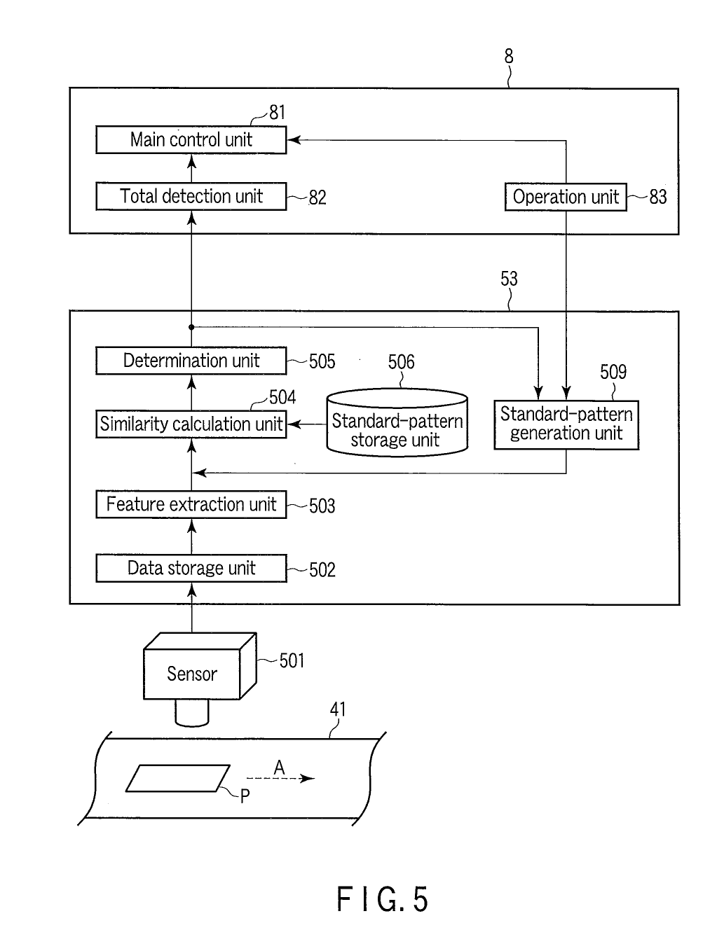

FIG. 5 is a view showing for explaining another example configuration of the category detection unit 53 shown in FIG. 1. The same parts of the configuration as those of the configuration shown in FIG. 2 will be denoted at the same reference symbols, and detailed descriptions thereof will be omitted.

The category detection unit 53 further comprises a standard-pattern generation unit 509. The standard-pattern generation unit 509 generates a new standard pattern (virtual standard pattern), based on standard patterns stored in the standard-pattern storage unit 506.

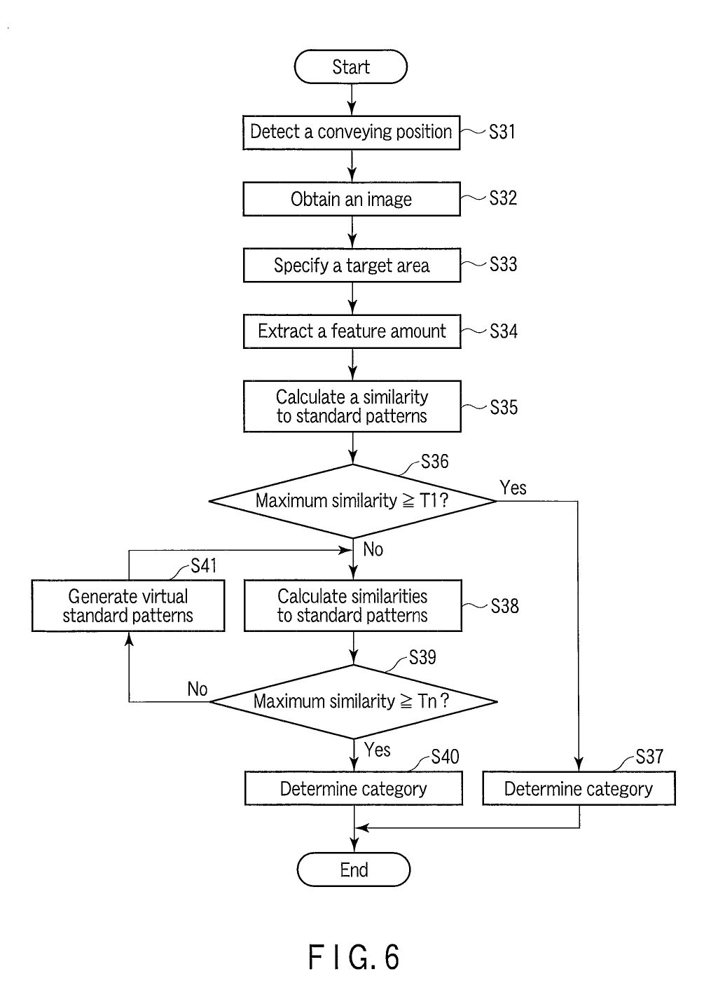

FIG. 6 is a view showing for explaining an operation of the category detection unit 53 in the sheet processing apparatus 100 shown in FIG. 5.

The category detection unit 53 recognizes a conveying position of a sheet P (step S31). If a sheet P is determined to have reached a detection position of a sensor 501 shown in FIG. 5, the category detection unit 53 obtains an image from the sheet P by the sensor 501 (step S32).

The category detection unit 53 specifies a target area where a feature amount is to be extracted by the feature extraction unit 503 (step S33). The category detection unit 53 extracts a feature amount, based on the image obtained by the sensor 501 and the specified target area (step S34).

The category detection unit 53 calculates similarities between a feature amount extracted by the feature extraction unit 503 and standard patterns stored in the standard-pattern storage unit 506 (step S35). Here, the category detection unit 53 selects a standard pattern group having a lowest soil level among standard pattern groups stored in the standard-pattern storage unit 506. In the present embodiment, the category detection unit 53 selects the first standard pattern group 507. The category detection unit 53 calculates a similarity between each of standard patterns comprised in the first standard pattern group 507 the feature amount extracted by the feature extraction unit 503.

Further, the category detection unit 53 specifies a maximum similarity, based on the calculated similarities. The category detection unit 53 compares a threshold T1 which the selected first standard pattern group 507 has with the specified maximum similarity. Specifically, the category detection unit 53 determines whether the maximum similarity is greater than or equal to the threshold T1 or not (step S36).

If the maximum similarity is not smaller than the threshold T1, the category detection unit 53 determines a category of the sheet P (step S17). Specifically, the category detection unit 53 determines that a category of a standard pattern used for calculating the maximum similarity corresponds to the category of the sheet P.

Otherwise, if the maximum similarity is smaller than the threshold T1, the category detection unit 53 calculates a similarity by using a standard pattern having a second lowest soil level (step S18). Here, the category detection unit 53 selects the second standard pattern group 508 having a second lowest soil level next to the first standard pattern group 507. The category detection unit 53 calculates a similarity between each of standard patterns comprised in the selected second standard pattern group 508 and the feature amount extracted by the feature extraction unit 503.

Further, the category detection unit 53 specifies a maximum similarity, based on the calculated similarities. The category detection unit 53 compares the threshold T2 which the selected second standard pattern group 508 has with the specified maximum similarity. Specifically, the category detection unit 53 determines whether the maximum similarity is equal to or greater than the threshold T2 or not (step S39).

If the maximum similarity is equal to or greater than the threshold T2, the category detection unit 53 determines a category of the sheet P (step S40). Specifically, the category detection unit 53 determines that a category of a standard pattern used for calculating the maximum similarity corresponds to the category of the sheet P.

Otherwise, if the maximum similarity is smaller than the threshold T2, the category detection unit 53 generates virtual standard patterns (step S21). The standard-pattern generation unit 509 generates virtual standard patterns based on standard patterns stored in the standard-pattern storage unit 506.

The standard-pattern generation unit 509 calculates a weight parameter based on the similarities calculated by the similarity calculation unit 504. The standard-pattern generation unit 509 generates virtual standard patterns, based on the calculated weight parameter and standard patterns stored in the standard-pattern storage unit 506.

Where the weight parameter is Wₙ for a standard pattern group whose soil level is n and where a similarity is Sₙ between each of standard patterns included in the standard pattern group and a feature amount, the standard-pattern generation unit 509 then calculates the weight parameter Wₙ, based on an expression below.

$${W}_{n} = \frac{{S}_{n}}{\sum {S}_{n}} \qquad ( expression 1 )$$

Where the virtual standard pattern is r′ and where each of standard patterns included in a standard pattern group corresponding to a soil level n is rₙ, the standard-pattern generation unit 509 then calculates the virtual standard pattern, based on an expression below.

\vec{r′}=ΣWₙ\vec{rₙ} (expression 2)

The standard-pattern generation unit 509 generates a virtual standard pattern group by performing processings as described above on standard patterns corresponding respectively to individual categories. The standard-pattern generation unit 509 transfers the generated virtual standard pattern group to the similarity calculation unit 504. The standard-pattern generation unit 509 comprises preset thresholds.

The similarity calculation unit 504 calculates a similarity between each of the virtual standard patterns of the virtual standard pattern group transferred from the standard-pattern generation unit 509 and a feature amount extracted from the feature extraction unit 503. Further, the similarity calculation unit 504 specifies a maximum similarity, based on the calculated similarities. The similarity calculation unit 504 transfers the specified maximum similarity to the determination unit 505.

The determination unit 505 compares the maximum similarity transferred from the similarity calculation unit 504 with a threshold which the standard-pattern generation unit 509 has.

If the maximum similarity is not smaller than the threshold which the standard-pattern generation unit 509 has, the determination unit 505 determines that a category of a virtual standard pattern used for calculating the maximum similarity corresponds to the category of the sheet P.

Otherwise, if the maximum similarity is smaller than the threshold which the standard-pattern generation unit 509 comprises, the determination unit 505 controls the standard-pattern generation unit 509 so as to generate a next virtual standard pattern. The category detection unit 53 newly generates virtual standard patterns and calculates similarities.

As described above, the sheet processing apparatus 100 according to the present embodiment comprises the category detection unit 53. The category detection unit 53 comprises a standard pattern group for each of different soil levels. Each standard pattern group comprises standard patterns for each category, and thresholds. The category detection unit 53 generates virtual standard patterns, based on results of calculating similarities and standard patterns used for calculating the similarities. The category detection unit 53 calculates similarities, based on the generated virtual standard patterns and a feature amount. If a calculated similarity is not smaller than a present threshold, the category detection unit 53 determines a category of the sheet P.

In this manner, the category detection unit 53 can generate virtual standard patterns even when the standard-pattern storage unit 506 stores only a small variety of standard patterns. As a result, the category detection unit 53 can detect a category of a sheet P by using an adequate standard pattern. As a result, a sheet processing apparatus and a sheet processing method capable of more efficiently performing processings can be provided.

The category detection unit 53 may be configured to store newly generated virtual standard patterns into the standard-pattern storage unit 506. In this case, the category detection unit 53 may further be configured to store virtual standard patterns into the standard-pattern storage unit 506 for each of soil levels, by using the soil levels which are detected by the fitness detection unit 52.

In the above embodiment, the category detection unit 53 has been described to have a configuration of calculating a weight parameter each time required. However, the category detection unit 53 is not limited to this configuration. The category detection unit 53 may be configured to prestore a combination of weight parameters in the standard-pattern storage unit 506.

Functions described in the above embodiment may be constituted not only with use of hardware but also with use of software, for example, by making a computer read a program which describes the functions. Alternatively, the functions each may be constituted by appropriately selecting either software or hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sheet processing apparatus which determines a category of a sheet, comprising:
an image obtaining unit configured to obtain an image from the sheet;
a feature-amount extraction unit configured to extract a feature amount from the image obtained by the image obtaining unit;
a standard pattern storage unit configured to prestore a standard pattern group for each different soil level, the standard pattern group comprising a standard pattern for each category;
a selection unit configured to select one standard pattern group from a plurality of standard pattern groups prestored in the standard-pattern storage unit;
a similarity calculation unit configured to calculate a similarity, based on at least one standard pattern comprised in the one standard pattern group selected by the selection unit, and on the feature amount extracted by the feature-amount extraction unit;
a comparison unit configured to compare the similarity calculated by the similarity calculation unit with a preset threshold;
a determination unit configured to determine a category of the sheet when the similarity is equal to or greater than the threshold, as a result of comparison by the comparison unit; and
a control unit configured to control the selection unit to select one other standard pattern group which has not been selected among the plurality of standard pattern groups stored in the standard-pattern storage unit, when the similarity is smaller than the threshold, as a result of comparison by the comparison unit.

2. The sheet processing apparatus of claim 1, wherein
the similarity calculation unit calculates similarities, based on the plurality of standard patterns comprised in the one standard pattern group selected by the selection unit, and on the feature amount extracted by the feature-amount extraction unit,
the comparison unit specifies a maximum similarity among the similarities calculated for the respective standard patterns by the similarity calculation unit, and compares the specified maximum similarity with a preset threshold,
the determination unit determines a category of the sheet when the maximum similarity is equal to or greater than the threshold, as a result of comparison by the comparison unit, and
the control unit controls the selection unit to select one other standard pattern group which has not been selected among the plurality of standard pattern groups stored in the standard-pattern storage unit when the maximum similarity is smaller than the threshold, as a result of comparison by the comparison unit.

3. The sheet processing apparatus of claim 2, wherein the control unit controls the selection unit to select other one standard pattern group which has a lowest soil level and has not yet been selected among the plurality of standard pattern groups stored in the standard-pattern storage unit.

4. The sheet processing apparatus of claim 3, wherein
the standard-pattern storage unit prestores a threshold for each of the standard pattern groups; and
the comparison unit specifies a maximum similarity among similarities which are calculated for each of the standard patterns by the similarity calculation unit; and compares the specified maximum similarity with one of the thresholds stored in the standard-pattern storage unit.

5. The sheet processing apparatus of claim 3, wherein the control unit determines the sheet to be a discardable sheet when there is no standard pattern which has not yet been selected.

6. The sheet processing apparatus of claim 3, further comprising a standard pattern generation unit configured to generate a virtual standard pattern group, based on each of the standard patterns comprised in the standard pattern groups stored in the standard-pattern storage unit, wherein
the control unit controls the selection unit to select the virtual standard pattern group generated by the standard-pattern generation unit when there is no standard pattern group which has not yet been selected.

7. The sheet processing apparatus of claim 6, wherein the standard-pattern generation unit calculates a weight parameter, based on the similarities calculated by the similarity calculation unit, and generates the virtual standard pattern group, based on the calculated weight parameter and on each of standard patterns comprised in one standard pattern group used for calculating the similarities among the plurality of standard pattern groups.

8. The sheet processing apparatus of claim 6, wherein the standard-pattern generation unit generates the virtual standard pattern group, based on a prestored weight parameter and on standard patterns comprised in one standard pattern group used for calculating the similarities among the plurality of standard pattern groups.

9. The sheet processing apparatus of claim 2, further comprising:
a conveyor unit configured to convey the sheet; and
a sort processing unit configured to sort the sheet, based on a determination result of the determination unit.

10. A sheet processing method for use in a sheet processing apparatus which determines a category of a sheet, comprising:
obtaining an image from the sheet;
extracting a feature amount from the obtained image;
prestoring a standard pattern group for each different soil level, the standard pattern group comprising a standard pattern for each category;
selecting one standard pattern group from the prestored plurality of standard pattern groups;
calculating a similarity, based on at least one standard pattern comprised in the selected one standard pattern group, and on the extracted feature amount;
comparing the calculated similarity with a preset threshold;
determining a category of the sheet when the similarity is equal to or greater than the threshold, as a result of comparison; and
performing a control so as to select one other standard pattern group which has not been selected among the prestored plurality of standard pattern groups, when the similarity is smaller than the threshold, as a result of comparison.
